(19) United States
(12) Patent Application Publication
(10) Pub. No.: US 2011/0143073 A1
(43) Pub. Date: Jun. 16, 2011

(54) TAPE

(75) Inventor: Kris Vandermeulen, Bornem (BE)

(73) Assignee: DYMO, Sint-Niklaas (BE)

(21) Appl. No.: 13/057,642

(22) PCT Filed: Aug. 6, 2009
(86) PCT No.: PCT/EP2009/060177

§ 371 Date: Feb. 14, 2011

(30) Foreign Application Priority Data
Aug. 6, 2008 (GB) 0814429.7

(51) Int. Cl. G09F 3/10; G09F 3/02; C09J 7/02

(52) U.S. Cl. 428/41.8; 428/77

(57) ABSTRACT

A tape comprising a substrate layer having a first region and a second region, said first region having a side on which an image can be received; a first adhesive layer provided on a side of said second region, said side of the first region and said side of said second region being on a same side of said substrate layer, wherein said tape is configured such that said second region can overly the side of the first region on which an image can be received, with said first adhesive layer being between said first and second regions.

### REFERENCE TO RELATED APPLICATIONS

This application is the US National Phase under 35 USC §371 of PCT/EP2009/060177, filed Aug. 6, 2009, claiming priority to GB 0814429.7 filed Aug. 6, 2008.

### BACKGROUND

1. Field of the Disclosure

The present disclosure relates to a tape which can be used to produce a laminated label and to a cassette housing such a tape.

2. Description of Related Art

Tape printing apparatus, which print on tape, are known. Known examples are described in documents such as EP-A-322918 (Brother KKK) and EP-A-267890 (Varitronic). The known tape printing apparatus comprise a cassette receiving bay for receiving a cassette or tape holding case. In EP-A-267890, the tape holding case houses an ink ribbon and a substrate tape. The substrate tape comprises an upper image receiving layer secured to a backing layer by an adhesive. In this arrangement, an image is printed on upper surface of the image receiving tape. The backing layer can be removed so that the tape, with an image printed thereon can be adhered on a surface.

However, this system has the disadvantage that information which has been printed on the surface may be removed by scratching or the result of an interaction with a solvent. Further, the printed text can fade away and background of the label can discolor due to ultraviolet (UV) light and/or other environmental conditions.

In EP-A-322918, the tape holding case or cassette houses an ink ribbon, a transparent image receiving tape and a double-sided adhesive tape which is secured at one of its adhesive coated sides to the image tape after printing and which has a backing layer peelable from its other adhesive coated side. The double-sided adhesive tape is applied to the image printed on the image receiving tape. The printed image is thus protected as it is printed on one side of the image receiving tape but the opposite side of the image receiving tape is the uppermost surface in the final label. With this tape printing apparatus, the ink ribbon, the adhesive tape and the image receiving tape are contained the same cassette. However, this system requires that the lamination operation be performed inside the cassette and after the image has been printed on the image receiving layer. This means that the minimum distance between the end of the tape and the start of the image, refer to as the leader or the trailer is relatively long. The leader or the trailer is a blank margin. This is because the length of the leader or trailer is defined by the distance between the printer head and the cutter. The mechanism for carrying out the laminating is provided between the printer head and the cutter, leading disadvantageously to a relatively long leader or trailer. Additionally, the configuration of the cassette and tape printer is such that it is not possible to reverse feed the tape.

U.S. Pat. No. 7,249,902 and US2006/0292319 in the name of Seiko Epson Corporation describe arrangements in which half the layer on which an image is printed is removed and the backing layer is folded over the printed image. The latter application also describes an arrangement where the backing layer is removed and then adhered to the layer on which the image is printed. These arrangements are disadvantageous in that when in a cassette the width of the tape is double the width on which an image can be printed. This means that the cassette is bulky. Secondly, folding the backing layer over the image receiving tape is a fiddly operation. Finally, the tape printer needs to be modified in order to ensure that the user only prints on the part of the image receiving tape which is not removed.

It is an aim of some embodiments of the present disclosure to address or at least mitigate one or more of the problems described above.

### SUMMARY OF THE DISCLOSURE

According to one aspect of the present disclosure, there is provided a tape comprising a substrate layer having a first region and a second region, said first region having a side on which an image can be received; a first adhesive layer provided on a side of said second region, said side of the first region and said side of said second region being on a same side of said substrate layer, wherein said tape is configured such that said second region can overly the side of the first region on which an image can be received, with said first adhesive layer being between said first and second regions.

### BRIEF DESCRIPTION OF THE SEVERAL VIEWS OF THE DRAWING

For a better understanding of the present disclosure and as to how the same will may be carried into effect, reference will now be made by way of example to the accompanying drawings in which:

FIG. 1 shows a tape embodying the present disclosure in an unfolded stage;

FIG. 2 shows the tape of FIG. 1, in a folded configuration as received in a cassette;

FIG. 3 shows the tape of FIG. 1, with a surface adhered to an object, and the tape being in an unfolded configuration;

FIG. 4 shows the tape of FIG. 1 as adhered to an object;

FIG. 5 shows schematically a tape printer with which embodiments of the disclosure may be used;

FIG. 6 is diagrammatic sketch showing the control circuitry for the tape printer of FIG. 5;

FIG. 7 is a plan view showing a cassette inserted in a one cassette system tape printer;

FIG. 8 is a similar plan view to that of FIG. 7 showing a cassette without ink ribbon inserted in the tape printer; and

FIG. 9 shows a two cassettes inserted in a two cassette system tape printer.

### DETAILED DESCRIPTION OF THE PREFERRED EMBODIMENTS

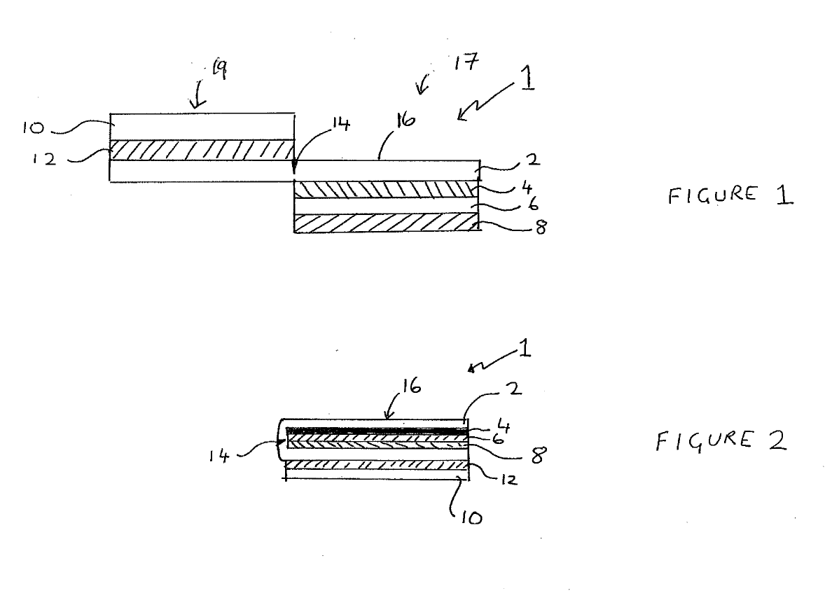

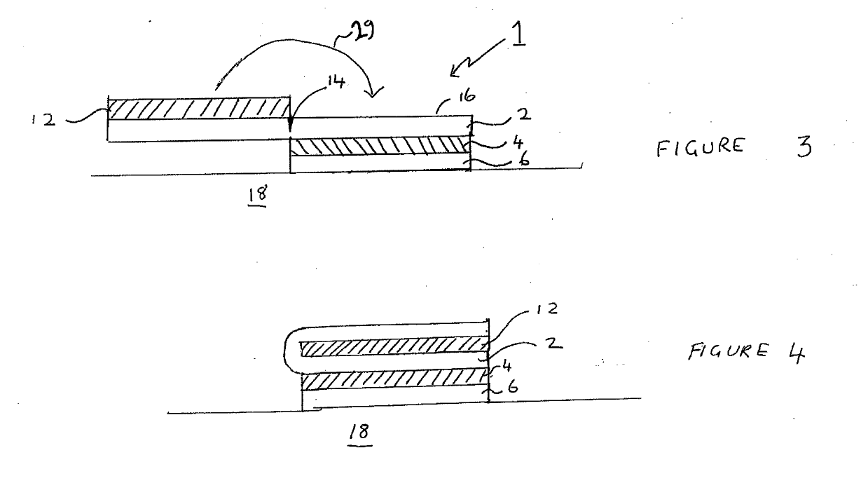

Reference will be first made to FIGS. 1 to 4 which show a tape 1 in various configurations. FIG. 1 shows the tape 1 in an unfolded configuration and FIG. 2 shows the tape in a folded configuration. The tape in this configuration may be housed in a cassette as described in more detail hereinafter.

It should be noted that the various hatching and shading shown in the figures have no significance and is there to assist in the discernment of the different layers. Additionally, the drawings shown in FIGS. 1 to 4 are not to scale. The thickness of the layers has been exaggerated for clarity.

The tape 1 has a substrate 2. This substrate, as described in more detail, is a single layer, one part of which provides an image receiving substrate and the other part of which provides a laminating layer. The laminating layer part of the single layer will overlies the image receiving substrate part of the single layer. In particular, the surface on which the image has been printed in the final label will be protected by the laminating layer part of the single layer. The substrate can thus be considered to have a first area 17 (the image receiving substrate) and a second area 19 (the laminating layer), which are arranged side by side across the width of the substrate 2, in the unfolded configuration. An image can be printed on the surface 16 of the first area 17 of the substrate 2. The tape shown in FIG. 1 is in its unfolded configuration, with cross-section being taken across the width of the tape. The tape 1 is such that the first area of the substrate 2 has various layers adhered to one side of the substrate whilst for the second area of the substrate, the layers are adhered to the opposite side.

In preferred embodiments of the present disclosure, for approximately half of the width of the substrate, the layers are adhered to one side, whilst for the other half, the layers are adhered to the opposite side. In other words the first and second areas are substantially the same size with the boundary between the two areas lying substantially in the middle of the substrate. However, it should be appreciated that in alternative embodiments of the present disclosure, it is possible that the proportions are different. One area may be larger than the other. It should also be appreciated that in the illustrated embodiment, the tape is such that for the entire width of the substrate, layers are adhered to one or other side of that substrate. However, in alternative embodiments, it is possible that at least part of the substrate may be such that a portion of the substrate does not have layers applied to either side thereof. In such embodiments, that area may be in a centre region, displaced to one or other side, or provided at one end region of the substrate. There may be one or more of these portions to which no layers are applied.

As shown in FIG. 1, the first area of the substrate 2 which has the surface on which the image is printed is such that the layers are applied to the opposite surface to that which receives the printed layer. Thus, the layers which are applied to the opposite surface of the substrate comprise a color layer 4. This is an optional layer which may be provided if a label other than a clear label is to be provided. Usually, the substrate is of a clear, transparent material.

In some embodiments of the present disclosure, the substrate 2 may incorporate some color. In such embodiments, the ink layer may be omitted or be additionally provided.

Next, a layer of adhesive 6 is provided. The adhesive layer 6 is covered with a liner layer 8. This liner layer 8 is such that it can be easily removed from the adhesive layer to allow the label to be adhered to a surface, as will described in more detail later. Alternatively, the liner layer 8 comprises two parts next to each other in the length direction of the tape such that the liner can be easily removed from the other layers before applying the label to an object.

On the same surface 16 of the substrate which an image is printed, layers are also applied, but in the second area 19. The two areas 17 and 19 of the substrate are defined by a cut or slit 14. This cut 14 extends part of the way into the substrate 2 to facilitate folding as will be described in relation to FIGS. 2 and 4.

It should be appreciated that in alternative embodiments of the present disclosure, the cut 14 may be replaced by a fold line, a score or in some embodiments be omitted completely. Alternatively or additionally, the a cut can be provided in the surface opposite to the printed surface, A cut may be provided on both sides of the substrate leaving some connecting material in the middle of the substrate layer to connect first area 17 and second area 19.

Applied to the upper surface of the substrate 2 in the second area, is an adhesive layer 12. Applied to the upper surface of the adhesive layer is a liner layer 10, operating in a similar manner to the liner layer 8. The liner layer 10 may also be a slit liner as discussed above in relation to liner layer 8.

In alternative embodiments of the present disclosure, the substrate 2 may comprise an ultraviolet blocker or ultraviolet blockers. The ultraviolet blocker(s) may be part of the substrate or provided as a coating on one or both sides of the substrate. Alternatively or additionally an additional layer or film may be provided comprising the ultraviolet blocker(s). The ultraviolet blocker(s) may be provided in the first area or the second area or both of the first and second areas.

In preferred embodiments of the present disclosure, the tape shown in FIG. 1 is incorporated in a cassette, such as illustrated and described hereinafter. In order to accommodate the tape shown in FIG. 1 in a cassette, the tape is folded about a line between the first area 17 and the second are 19 to adopt the configuration shown in FIG. 2. Thus, the surface 16 of the substrate 2 to which an image is applied is uppermost followed by the optional ink layer 4, the adhesive layer 6 and the liner layer 8. Additionally, since the second area of the substrate has been folded, layer 8 is placed adjacent to the second area of the substrate 2, with the adhesive layer 12 being next and finally the backing layer 10.

This arrangement has an advantage that the width of the cassette is less than that which would be required if the tape was not in the folded configuration.

As will be described in more detail hereinafter, an image is printed on the surface 16, whilst the tape is in a tape printing apparatus. The tape is then cut and removed from the tape printing apparatus.

FIGS. 3 and 4 show how the tape is then applied to an object, after an image has been printed on the surface 16 and the portion on which the image has been printed has been cut off. As shown in FIG. 3, the liner layer 8 of the first area is removed so that the adhesive layer 6 is exposed and can be adhered to an object 18.

The liner layer 10 of the second area is also removed. The tape is then moved again into a folded configuration as shown by the arrow 29. In other words, the adhesive layer 12 of the second area is brought into contact with the surface 16 of the substrate to which an image has been applied. This makes the second area of the substrate 2 uppermost.

FIG. 4 illustrates the label as applied to an object. Thus, there is an adhesive layer 6 applied to the object 18. On top of that adhesive layer is the optional ink layer 4, backing onto the first area of the substrate 2. It is on the upper surface of this area of the substrate that the image is printed. That upper surface is then covered by the adhesive layer 12 and finally, the second area of the substrate 2 covers the adhesive layer.

In this way, an image can be printed on a substrate and is then protected by a substrate after printing so that the durability of the label is improved.

In preferred embodiments of the present disclosure, the entire substrate is transparent so that the second area of the substrate can provide a clear window on top of the printed image. However, in some embodiments of the present disclosure, the substrate may be transparent but colored. In alternative embodiments of the present disclosure, one area of the substrate may be transparent and/or clear, without any color whilst the second area of the substrate is opaque or colored. It is this area of the substrate which the image will be applied.

In preferred embodiments of the present disclosure, the adhesive 12 is selected such that it is also clear at the thicknesses used in embodiments of the present disclosure.

In preferred embodiments of the present disclosure have been described in the context of a continuous tape which is cut to a desired length using a cutter. However, in alternative embodiments of the present disclosure, discrete die cut layers may be provided on a continuous backing layer. For example, layer 10 may be continuous whilst at least the substrate 2 may be of a predefined length. In this way, the need for a cutter can be avoided.

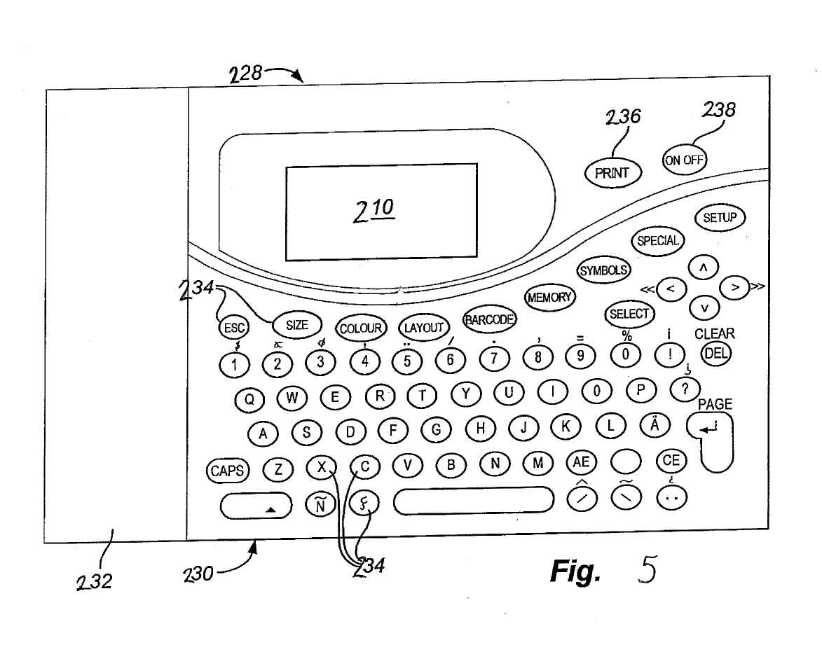

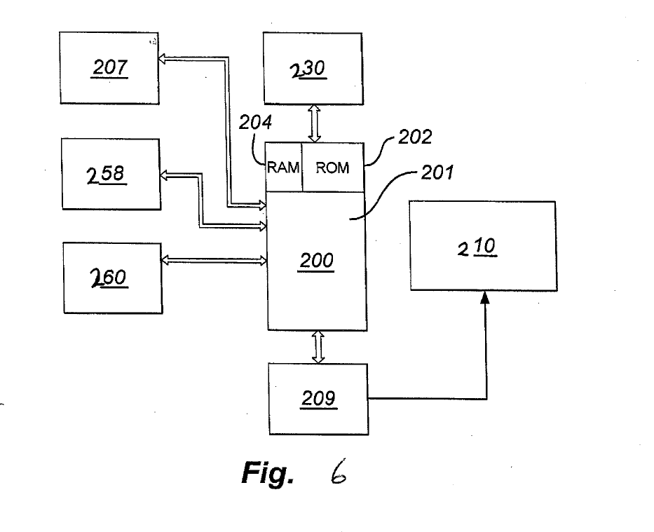

FIG. 5 shows a schematic diagram of a tape printing apparatus 228 with which tape embodying the present disclosure can be used. The tape printing apparatus comprises a keyboard 230 and a cassette receiving bay 232. The keyboard has a plurality of data entry keys 234 such as numbered, lettered and punctuation keys for inputting data to be printed on the label and function keys for editing the input data. The keyboard may also have a print key 236 which is operated when it is desired that a label be printed. Additionally an on/off key 238 is also provided for switching the tape printing apparatus on and off.

The tape printing apparatus has a liquid crystal display (LCD) 210 which displays the data as it is entered. The display allows the user to view all or part of the label to be printed which facilitates the editing of the label prior to its printing. Additionally, the display is driven by a display driver (not shown).

Basic circuitry for controlling the tape printing device 228 is shown in FIG. 6. There is a microprocessor chip 200 having a read only memory (ROM) 202, a microprocessor 201 and random access memory capacity indicated diagrammatically by RAM 204. The microprocessor chip 200 is connected to receive label data input to it from a data input device such as a keyboard 230. The microprocessor chip 200 outputs data to drive a display 210 via a display driver chip 209 to display a label to be printed (or a part thereof) and/or a message for the user. The display driver alternatively may form part of the microprocessor chip. Additionally, the microprocessor chip 200 also outputs data to drive the print head 260 so that the label data is printed onto the image receiving tape to form a label. The microprocessor chip 200 also controls a motor 207 for driving the tape. The manner in which the tape may be driven will be discussed hereinafter. Finally the microprocessor chip 200 also controls the cutting mechanism 258 to allow a length of tape to be cut off.

The motor 207 may be a stepper motor or a DC motor controlled by an encoder arrangement or the like.

It should be appreciated that in some embodiments of the present disclosure, a manual cutter mechanism may be alternatively provided.

The operation of the label printer will now be described. Data to be printed is input into the label printing device using the data input device, for example using keys on the keyboard 230. As the data is entered via the keyboard 230 it is supplied to the microprocessor which causes the display 210 to display the data as it is entered. To do this, for each character which is entered, the microprocessor calls up a stored version of the character from the ROM 202. As the character is stored in compressed form, this font data is stored temporarily in the RAM 204 and is manipulated by the microprocessor 200 to generate pixel data to form the character. This pixel data is transmitted in one form to the display 210 and in another form to the print head for printing. Character data is not passed to the print head for printing until the print operation is executed.

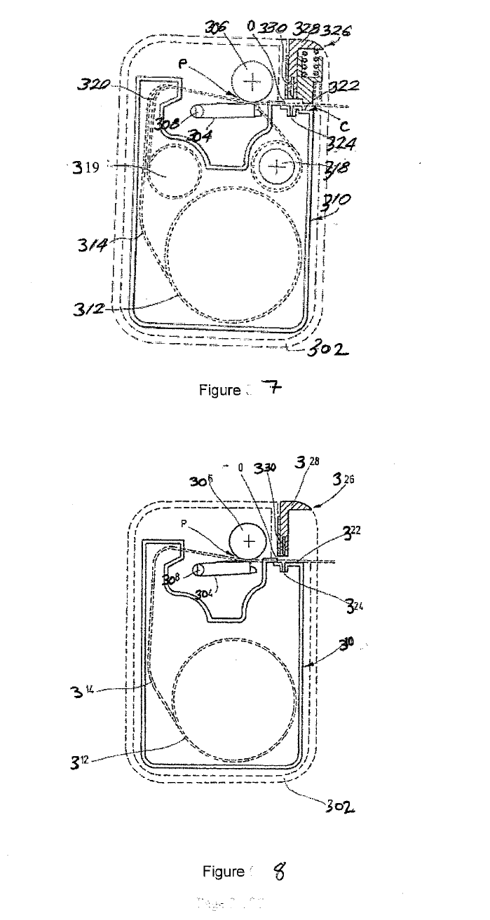

Reference is now made to FIG. 7 which illustrates in plan view a cassette bay of the label printer. The cassette bay is shown by the dotted line 302. The cassette receiving bay includes a thermal print head 304 and a platen 306 which co-operate to define a print location P in a manner which is known in the art. The print head 304 is pivotable about a pivot point 308 so that it can be brought into contact with a platen 306 for printing and moved away from the platen to enable a cassette to be removed and replaced.

The cassette inserted into the cassette bay is denoted generally by the reference number 310. The cassette holds a supply spool 312 of image receiving medium 314. The image receiving medium 314 is guided by a guide mechanism through the cassette, out of the cassette through an outlet 0, passed the print location P to a cutting location C. The image receiving medium 314 is the tape, in the configuration shown in FIG. 2. The cassette also has an ink ribbon supply spool 319 and an ink ribbon take up spool 318. The ink ribbon 320 is guided from the ink ribbon supply spool 319 through the print location P and is taken up on the ink ribbon take up spool 318. The image receiving medium passes in overlap with the ink ribbon through the print location with the image receiving medium in contact with the ink ribbon.

The platen 306 is driven so that it rotates to drive the image receiving medium 314 past the print location for printing. In this way, image receiving medium is printed and fed out from the print location P to the cutting location C. The cutting location C may be provided at any suitable location, for example downstream of the cassette. However, in preferred embodiments of the present disclosure, the cutting location may be provided at a location on a portion of the wall of cassette 310 which is close to the print location P. As the image receiving medium is fed out of the cassette by driving the platen, there is no need for a further feed mechanism for the image receiving medium and this enables the cutting location C to be closer to the print location P.

The portion of the wall of the cassette where the cutting location C is defined is denoted by reference numeral 322. A slot 324 is defined in the wall portion and the image receiving medium 314 is feed past the print location P to the cutting location C where it is supported by facing wall portion on either side of the slot. The label printer includes a cutting mechanism generally denoted by reference numeral 326. This cutting mechanism includes a cutter support member 328 which carries a blade 330. The blade 330 cuts the image receiving medium and then enters the slot 324 with the leading part of its edge first, rather than bearing against an anvil.

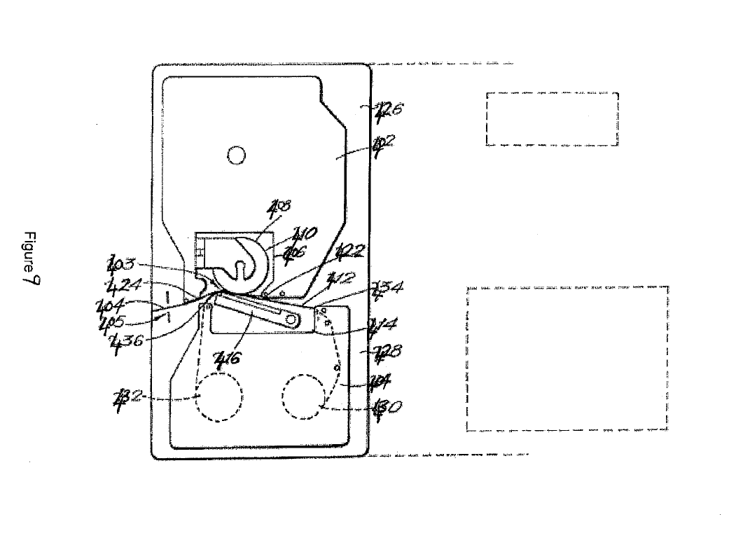

The cassette shown in FIG. 7 can be modified so as to only include the image receiving medium. The modified cassette is shown in FIG. 8. FIG. 8 illustrates a horizontal section through a cassette receiving member of a printing device. The cassette receiving member is shown by the dotted line 302. The cassette receiving member 302 includes a thermal print head 304 and a platen 306 which cooperate to define a print location P in the same way as described in FIG. 7. The thermal print head is in this embodiment in contact with the image receiving medium. The image receiving medium has at least one thermally sensitive layer so that an image is formed in the image receiving medium when the print head is heated. In this embodiment, the substrate of the image receiving tape of FIGS. 1 to 4 is thermally sensitive so that an image is printed without the need with for an ink. The laminating layer provides extra stability to the thermally generated image.

Reference will now be made to FIG. 9 which shows in plan view two cassettes arranged in a label printer. The upper cassette 402 is located in the first cassette receiving portion 426 and contains a supply of image receiving medium 404 which passes through a print zone 403 in the label printer to an outlet 405 for the printer. This is the image receiving tape is as shown in FIG. 2, in the configuration shown in that Figure.

The cassette 402 has a recess 406 for accommodating a platen 408 of the printer and guide portions 422, 424 for guiding the image receiving medium 404 through the print zone. The platen 408 is mounted for rotation within a cage moulding 410. As an alternative, the platen 408 could be mounted for rotation on a pin. The lower cassette 444 is located in the second cassette receiving portion 428 and contains a thermal transfer ribbon which extends from a supply spool 430 to a take up spool 432 within the cassette 444. The thermal transfer ribbon 412 extends to the print zone 403 in overlap with the image receiving medium 404. The cassette 444 has a recess 414 for receiving a print head 416 of the printer and guide portions 434, 436 for guiding the ink ribbon 412 through the print zone 403.

The print head 416 is moveable between an operative position, shown in FIG. 9, in which it is in contact with the platen and holds the thermal transfer ribbon 412 and the image receiving medium 404 in overlap between the print head and the platen and an inoperative position in which it is moved away from the platen to release the thermal transfer ribbon and image receiving medium. In the operative position, the platen is rotated to cause the image receiving medium to be driven past the print head and the print head is controlled to print an image on to the image receiving medium by thermal transfer of ink from the ribbon 412.

The print head is a conventional thermal print head having an array of pixels each of which can be thermally activated in accordance with the desired image to be printed.

It should be appreciated that since lamination only occurs once the tape has been removed from the tape printer, the tape can be reversed back in the tape printer without problems.

The embodiments shown have been stand alone printers. Embodiments of the present disclosure may be used with used with tape printers which can be connected to a personal computer (PC). Such tape printers may not have a keyboard or display, instead of which those of the PC are used.

I claim:

1. A tape comprising:
a substrate layer having a first region and a second region, said first region having a side on which an image can be received;
a first adhesive layer provided on a side of said second region, said side of the first region and said side of said second region being on a same side of said substrate layer, wherein said tape is configured such that said second region can overly the side of the first region on which an image can be received, with said first adhesive layer being between said first and second regions.

2. A tape as claimed in claim 1, comprising a second adhesive layer provided on a side of said first region opposite to said side on which an image can be received;

3. A tape as claimed in claim 2, wherein a colored layer is provided between said first region and said second adhesive layer.

4. A tape as claimed in claim 3, wherein said colored layer comprises an ink layer.

5. A tape as claimed in claim 1, wherein at least one of said first and second adhesive layer comprises a removable liner layer on a side of said adhesive layer further from said substrate.

6. A tape as claimed in claim 1, wherein said first region and said second region are substantially the same size.

7. A tape as claimed in claim 1, wherein at least the second region is substantially transparent.

8. A tape as claimed in claim 1, wherein said first and second regions are separated by one of a fold line; at least one score mark; and at least one cut extending only partially through said substrate layer.

9. A tape as claimed in any claim 8, wherein said first and second regions are separated on one or two sides of said substrate layer.

10. A tape as claimed in claim 1, wherein said tape has a storage configuration in which the side of said first region on which an image can be received is outermost, and said first and second regions of said substrate are such that one of said first and second regions overlies the other of said first and second regions.

11. A tape as claimed in claim 1 comprising ultraviolet blockers.

12. A tape as claimed in claim 11, wherein said substrate layer comprises, in at least one of said first and second regions, said ultraviolet blockers.

13. A tape as claimed in claim 11, wherein said ultraviolet blockers are provided by a coating.

14. A cassette comprising a tape as claimed claim 1.
